(19) United States
(12) Patent Application Publication
(10) Pub. No.: US 2011/0218863 A1
(43) Pub. Date: Sep. 8, 2011

(54) METHOD AND SYSTEM FOR AUTOMATICALLY CHARGING ADVERTISEMENT FEES

(75) Inventors: Hye Jung Roh, Seongnam-si (KR); Jiyoung Choi, Seongnam-si (KR)

(73) Assignee: NHN BUSINESS PLATFORM CORPORATION, Seongnam-si (KR)

(21) Appl. No.: 13/061,442

(22) PCT Filed: Aug. 28, 2009
(86) PCT No.: PCT/KR2009/004837

§ 371 Date: May 24, 2011

(30) Foreign Application Priority Data
Aug. 28, 2008 (KR) 10-2008-0084396

(51) Int. Cl. G06Q 30/00

(52) U.S. Cl. 705/14.69

(57) ABSTRACT

A method and system for automatically recharging an advertising fee are provided. The method includes managing payment information related to the advertising fee, the payment information to suspend an advertisement exposure service based on a balance of the advertising fee for a first time period and to perform automatic recharging of the advertising fee for a second time period which is shorter than the first time period; automatically recharging the advertising fee by the second time period according to the payment information; and notifying a result of the automatic recharging.

### TECHNICAL FIELD

The present invention relates to a method and system for automatically recharging an advertising fee, and more particularly, to a method and system for automatically recharging an advertising fee according to payment information related to the advertising fee and notifying a result of the automatic recharging.

### BACKGROUND ART

According to general online advertising, an advertisement is exposed through an advertisement region defined on a webpage to users who access the webpage through the Internet. Advertising fee is charged to an advertiser, corresponding to a number of exposures of an advertisement or a number of clicks of the exposed advertisement.

In general, according to the online advertising, the advertising fee may be charged weekly or monthly, or a deposit for the advertising fee may be paid in advance and so that the advertising fee is deducted from the deposit.

Conventionally, when the advertising fee is paid by the deposit, advertising is performed within a range of the deposit paid by the advertiser and no longer performed when the deposit is exhausted. Thus, to maintain the advertising, the advertiser needs to check a balance of the deposit and additionally pay a deposit when the deposit is exhausted, which is bothersome to the advertiser.

Accordingly, there is a desire for a new method enabling an advertiser to automatically recharge the advertising fee without having to frequently check the advertising fee.

### DISCLOSURE OF INVENTION

### Technical Goals

An aspect of the present invention provides a method and system capable of automatically recharging an advertising fee according to payment information related to the advertising fee and notifying a result of the automatic recharging related to the advertising fee.

Another aspect of the present invention provides a method and system capable of automatically recharging the advertising fee in a period shorter than an advertisement exposure suspension period to minimize suspension of the advertisement exposure caused due to exhaustion of the advertising fee.

Still another aspect of the present invention provides a method and system capable of managing payment information related to the advertising fee, in order to minimize inconvenience of inputting credit card information or executing a wire transfer every time recharging of the advertising fee is required.

A further aspect of the present invention provides a method and system capable of minimizing exhaustion of the advertising fee by automatically recharging the advertising fee and also minimizing loss of sales opportunity with respect to the advertisement exposure by securing a deposit for the advertising fee.

### Technical Solutions

According to an aspect of the present invention, there is provided a method for automatically recharging an advertising fee, the method including managing payment information related to the advertising fee, the payment information to suspend an advertisement exposure service based on a balance of the advertising fee for a first time period and to perform automatic recharging of the advertising fee for a second time period which is shorter than the first time period; automatically recharging the advertising fee by the second time period according to the payment information; and notifying a result of the automatic recharging.

According to an aspect of the present invention, there is provided a system for automatically recharging an advertising fee, the system including a payment information management unit to manage payment information related to the advertising fee, the payment information to suspend an advertisement exposure service based on a balance of the advertising fee for a first time period and to perform automatic recharging of the advertising fee for a second time period which is shorter than the first time period; an automatic recharging unit to automatically recharge the advertising fee by the second time period according to the payment information; and a notification unit to notify a result of the automatic recharging.

### Effects

According to embodiments of the present invention, since an advertising fee is automatically recharged according to payment information related to the advertising fee and the recharging result is notified, an advertiser may conveniently recharge the advertising fee within a predetermined period and predetermined limit amount, without separately managing the advertising fee.

According to embodiments of the present invention, suspension of advertisement exposure, caused by exhaustion of the advertising fee, may be prevented by recharging a predetermined amount before the advertisement exposure is suspended or recharging an amount of N-times as much as an estimated charge.

According to embodiments of the present invention, an amount automatically recharged within a predetermined period may be controlled not to exceed a predetermined limit amount.

According to embodiments of the present invention, since the advertising fee is automatically recharged, suspension of the advertisement exposure, caused by exhaustion of the advertising fee, may be reduced.

According to embodiments of the present invention, since the advertising fee is automatically recharged, the advertisement may be continuously exposed without undesired suspension.

Additionally, according to embodiments of the present invention, even though an advertiser makes a late payment of the advertising fee, automatic payment may be performed so that a negative balance is not induced.

### BRIEF DESCRIPTION OF DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating associative relationships among an automatic recharging system, an advertiser terminal, and an advertisement exposing terminal, according to an embodiment of the present invention;

FIG. 2 is a diagram illustrating a structure of the automatic recharging system according to the embodiment of the present invention;

FIG. 3 is a diagram specifically illustrating a payment information management unit of the automatic recharging system according to the embodiment of the present invention;

FIG. 4 is a flowchart illustrating a process of an automatic recharging method according to an embodiment of the present invention;

FIG. 5 is a flowchart specifically illustrating a process of managing payment information in the automatic recharging method according to the embodiment of FIG. 4; and

FIG. 6 is a flowchart specifically illustrating a process of automatically recharging an advertising fee in the automatic recharging method according to the embodiment of FIG. 4.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

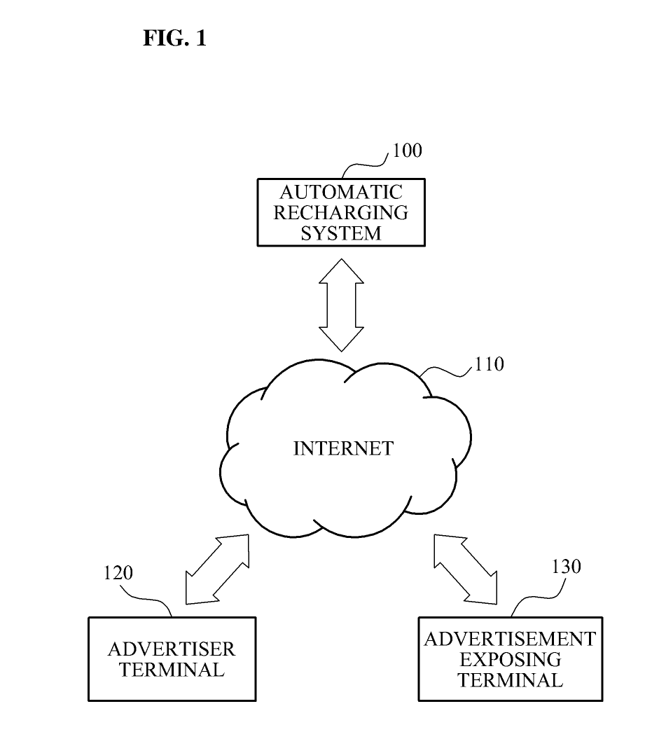

FIG. 1 is a diagram illustrating associative relationships among an automatic recharging system 100, an advertiser terminal 120, and an advertisement exposing terminal, according to an embodiment of the present invention.

Referring to FIG. 1, the automatic recharging system 100 may automatically recharge an advertising fee according to payment information related to the advertising fee, and notify a result of the recharging. For example, the automatic recharging system 100 may automatically recharge the advertising fee of an advertiser according to the payment information which is input by the advertiser per advertising account from the advertiser terminal 120 connected through the Internet 110. In addition the automatic recharging system 100 may notify the advertiser of a result of the recharging through the advertiser terminal 120.

The automatic recharging system 100 may be optionally set with the payment information related to the advertising fee, the payment information adapted to recharge a predetermined amount every predetermined period.

The automatic recharging system 100 may be optionally set with the payment information related to the advertising fee, the payment information adapted to recharge a predetermined amount or an amount of N-times an estimated charge when the advertising fee is predicted to be exhausted or before the advertising fee is exhausted.

In other words, the automatic recharging system 100 may prevent exposure of an advertisement from being suspended due to lack of the advertising fee, by recharging the advertising fee before the suspension happens. Thus, the automatic recharging system 100 may enable continuous exposure of the advertisement through recharging of the advertising fee, preventing undesired suspension of the advertisement exposure.

The automatic recharging system 100 may be optionally set with the payment information related to the advertising fee, the payment information adapted to control an amount automatically recharged in a predetermined period not to exceed a predetermined limit amount.

When a credit card is used as a payment method, the automatic recharging system 100 may check validity of the credit card and accordingly register the credit card. Also, a backup credit card may be registered in the automatic recharging system 100.

When a wire transfer is used as the payment method, the automatic recharging system 100 may check validity of an account number and accordingly register the account number. Also, a backup account number may be registered in the automatic recharging system 100.

Even when the advertiser is expanded to an advertiser who makes a late payment, the automatic recharging system 100 may be set to perform automatic payment to reduce occurrence of a negative balance. In other words, the automatic recharging system 100 may apply not only an advance payment system for stably securing a deposit to expand a base of sales increase but also a pay-later payment system for securing sales with low risk.

The advertiser terminal 120 may register an advertisement designated by the advertiser to the automatic recharging system 100 connected through the Internet 110 according to the advertising account. Also, the advertiser terminal 120 registers the payment information for automatic advertising of the advertising fee corresponding to the registered advertisement. For example, when the advertiser wants to post an advertisement A for a predetermined period, the advertiser terminal 120 may register a recharged amount per time, a maximum monthly limit of the recharged amount, a recharging time, and the like as payment information in the automatic recharging system 100 connected through the Internet 110, the payment information for automatically recharging the advertising fee of the advertisement A. For example, the recharged amount per time may be selected by the advertiser within a range of predetermined amounts, for example, among 50,000 won/time 100,000 won/time 200,000 won/time 300,000 won/time. However, the advertiser may directly input a desired amount. The payment information on the recharging time may include a starting date or expiration date of the recharging.

The automatic recharging system 100 may suspend an advertisement exposure service based on a balance of the advertising fee by a first period, manage the payment information related to automatic recharging of the advertising fee for a second period which is shorter than the first period, and automatically recharge the advertising fee corresponding to the advertiser according to the payment information. More specifically, the automatic recharging system 100 may perform suspension of the advertisement exposure for the first period based on the balance of the advertising fee, and automatically recharges the advertising fee corresponding to the advertiser for the second period. Here, the first period is for suspension of the advertisement exposure service based on the balance of the advertising fee while the second period is for recharging of the advertising fee for a shorter time than the first period so as to maintain the advertisement exposure service. For example, the automatic recharging system 100 may suspend the advertisement exposure service based on the balance in a 30-minute period, and automatically recharge the advertising fee in a 10-minute period.

In an example case where the recharged amount per time is ‘50,000 won’, the maximum monthly limit of the recharged amount is ‘500,000 won’, and the expiration date is ‘Aug. 31, 2000’, when the advertising fee paid according to the advertising account is lacking, the automatic recharging system 100 may automatically recharge ‘50,000 won’ which is the recharged amount per time in the second period, and also automatically recharge the advertising fee not to exceed ‘500,000 won’ which is the maximum monthly limit, by ‘Aug. 31, 2000’ which is the expiration date.

The automatic recharging system 100 may expose the advertisement registered by the advertiser through the advertisement exposing terminal 130 connected through the Internet 110 by performing the advertising according to the recharged advertising fee. For example, after the advertising fee is automatically recharged for a predetermined time, when the recharged advertising fee is greater than the advertising fee required for the advertising, the automatic recharging system 100 may expose the advertisement through the advertisement exposing terminal 130 connected through the Internet 110. Conversely, when the recharged advertising fee is less than the required advertising fee, the automatic recharging system 100 may suspend exposure of the advertisement through the advertisement exposing terminal 130 connected through the Internet 110 in the first period.

The advertisement exposing terminal 130 may expose the advertisement contained in a webpage being supplied from the automatic recharging system 100 by connecting to the automatic recharging system 100 through the Internet 110.

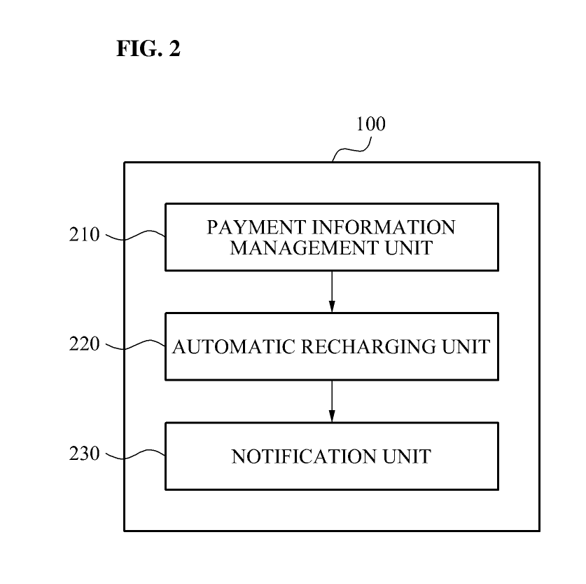

FIG. 2 illustrates a structure of the automatic recharging system 100 according to the embodiment of the present invention.

Referring to FIG. 2, the automatic recharging system 100 may include a payment information management unit 210, an automatic recharging unit 220, and a notification unit 230.

The payment information management unit 210 may perform suspension of the advertisement exposure service based on the balance of the advertising fee in the first period, and manage the payment information for the automatic recharging in the second period which is shorter than the first period. For example, when the automatic recharging is periodic, the payment information may include information on a recharging period to perform the automatic recharging according to a predetermined period, or information to recharge a predetermined amount. As another example, when the automatic recharging is balance-diminishing, the payment information may include information adapted to automatically recharge the predetermined amount or the amount of N-times the estimated charge when the advertising fee is predicted to be exhausted or before the advertising fee is exhausted. As still another example, the payment information may include information adapted to control the amount automatically recharged for the predetermined time not to exceed a predetermined amount.

That is, the payment information management unit 210 may be registered with the payment information related to the advertising fee according to the advertising account by the advertiser, and manage the registered payment information.

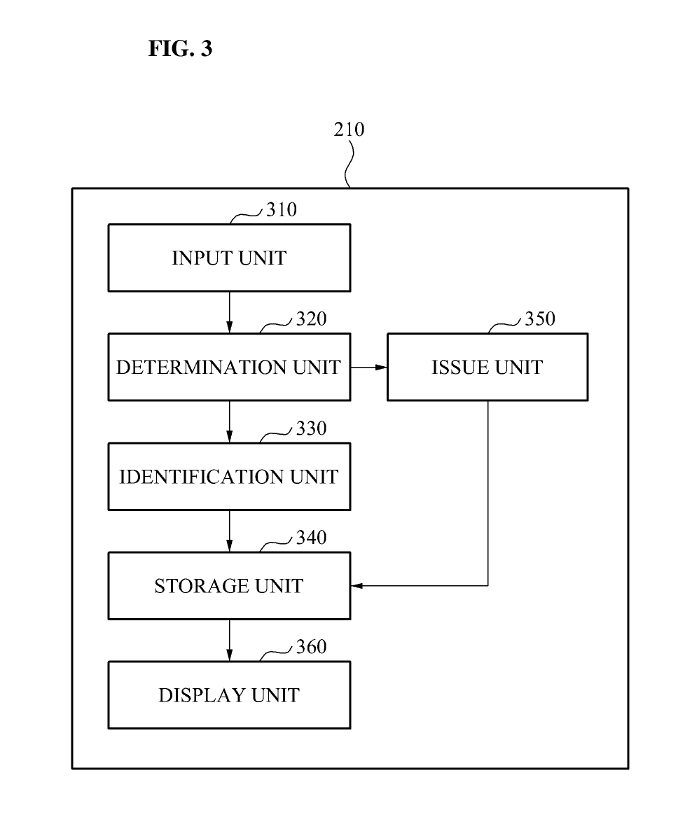

FIG. 3 is a diagram specifically illustrating a payment information management unit 210 of the automatic recharging system 100 according to the embodiment of the present invention.

Referring to FIG. 3, the payment information management unit 210 includes an input unit 310, a determination unit 320, an identification unit 330, a storage unit 340, and an issue unit 350.

The input unit 310 may be input by the advertiser with an automatic recharging mode per account for payment of the advertising fee, or with the payment information related to the advertising fee for the automatic recharging.

When the automatic recharging is periodic, the input unit 310 may be input with the payment information by the advertiser, the payment information adapted to automatically recharge the predetermined amount in the predetermined period.

When the automatic recharging is balance-diminishing, the input unit 310 may be input with the payment information by the advertiser, the payment information adapted to automatically recharge the predetermined amount or the amount of N-times the estimated charge when the advertising fee is predicted to be exhausted or before the advertising fee is exhausted.

The input unit 310 may be input with the payment information adapted to control the amount being automatically recharged for the predetermined time not to exceed the predetermined amount.

For example, the payment information input to the input unit 310 by the advertiser or a system manager may include the recharged amount per time according to the automatic recharging, the maximum monthly limit of the recharged amount, and a starting time or ending time.

For example, the payment information related to the automatic recharging of the advertising fee, which is input to the input unit 310, may include personal information, account information, credit card information, an account personal identification number (PIN), a credit card PIN, an authentication number, and the like of the advertiser. The account information of the advertiser may include information on a main account, and information on a backup account that may substitute for the main account in case that the main account is invalid. The credit card information of the advertiser may include information on a main credit card, and information on a backup credit card that may substitute for the main credit card in case that the main credit card is invalid. The determination unit 320 may determine whether the automatic recharging mode related to the advertising fee is selected. More specifically, the determination unit 320 may determine whether the automatic recharging mode is turned on or off by the advertiser.

The identification unit 330 may identify the payment information input by the advertiser. For example, the identification unit 330 may identify the personal information, the account information, the credit card information, the account PIN, the credit card PIN, the authentication number, and the like of the advertiser, as the payment information necessary for payment of the advertising fee.

The storage unit 340 may store the identified payment information. Specifically, the storage unit 340 may store the payment information for the automatic recharging of the advertising fee, identified by the identification unit 330. In addition to the payment information, the storage unit 340 may also store a bill key issued for the automatic recharging. The storage unit 340 may store the payment information updated according to a result of the automatic recharging. For example, when the automatic recharging succeeds, the payment information containing updated balance information may be stored in the storage unit 340.

The issue unit 350 may issue the bill key related to the payment information according to a result of determining validity of the identified payment information. More specifically, when the identified payment information is determined to be valid, the issue unit 350 may issue the bill key related to the payment information for the automatic recharging of the advertising fee.

The display unit 360 may display a change history related to the updated payment information.

The automatic recharging unit 220 may automatically recharge the advertising fee corresponding to the advertiser in the second period according to the payment information for the automatic recharging. The automatic recharging unit 220 may perform payment for the automatic recharging using the bill key when recharging using the bill key is requested.

For example, when payment for the automatic recharging fails, it is requested to perform the recharging again using the backup credit card. Accordingly, the automatic recharging unit 220 may perform payment for the automatic recharging using the backup credit card according to the request.

The notification unit 230 may notify the result of the automatic recharging. That is, the notification unit 230 may notify the advertiser or the system manager of the result of the automatic recharging of the advertising fee.

For example, the notification unit 230 may transmit a payment success message, a payment failure message, or a result notifying message to the advertiser terminal according to the result of the automatic recharging, thereby notifying the advertiser of the result.

For example, when payment for the automatic recharging succeeds or payment using the backup credit card succeeds, the notification unit 230 may transmit the payment success message to the advertiser terminal, thereby notifying the advertiser of the success of the automatic recharging.

Also, when payment for the automatic recharging fails or payment using the backup credit card fails, the notification unit 230 may transmit the payment failure message to the advertiser terminal, thereby notifying the advertiser of the failure of the automatic recharging.

In addition, when the recharged amount related to the automatic recharging exceeds the maximum monthly limit or when the expiration date for the automatic recharge is passed, the notification unit 230 may transmit the result notifying message to the advertiser terminal, thereby notifying the advertiser of the payment information related to the automatic recharging.

Thus, the automatic recharging system 100 described above automatically recharges the advertising fee according to the payment information, and notifies the result of the automatic recharging of the advertising fee. Therefore, the advertiser may be able to conveniently and automatically recharge the advertising fee within a limit amount for the predetermined period without having to separately managing payment of the advertising fee.

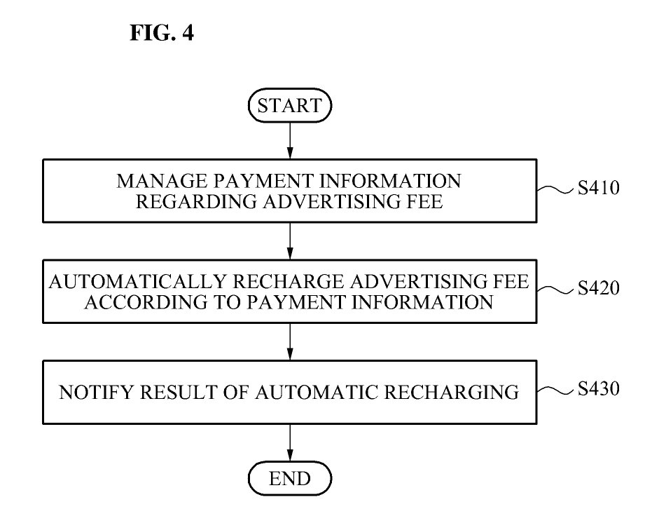

FIG. 4 is a flowchart illustrating a process of an automatic recharging method according to an embodiment of the present invention.

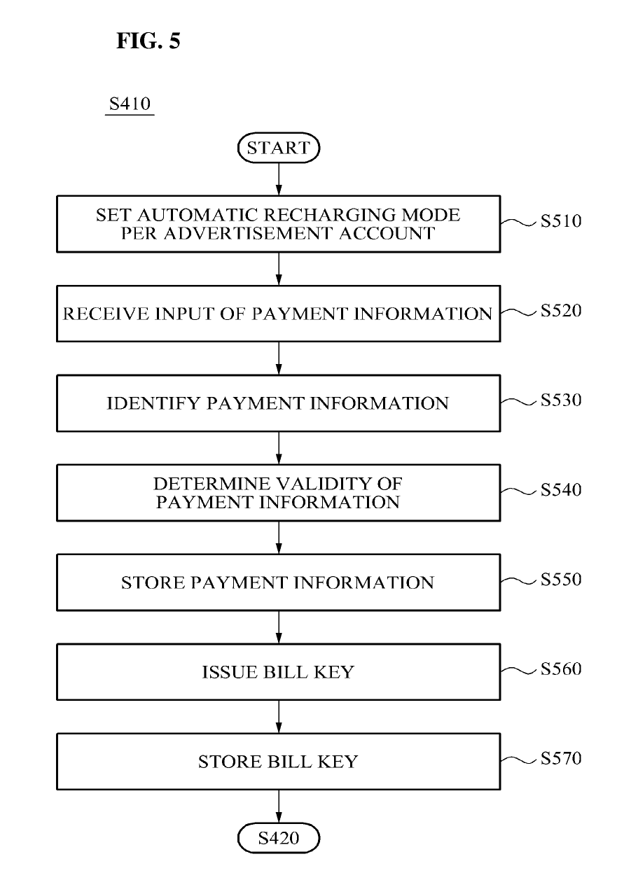

Referring to FIGS. 1 and 4, in operation S410, the automatic recharging system 100 manages the payment information related to the advertising fee, such that the advertisement exposure service is suspended based on the balance of the advertising fee in the first period, and the automatic recharging is performed in the second period shorter than the first period. That is, in operation S410, the automatic recharging system 100 manages the payment information related to the advertising fee input by the advertiser per the advertising account through the advertiser terminal 120 connected through the Internet 110. Hereinafter, the operation of managing the payment information for the automatic recharging of the advertising fee will be described in further detail with reference to FIG. 5.

FIG. 5 is a flowchart specifically illustrating a process of managing the payment information in the automatic recharging method according to the embodiment of the present invention.

Referring to FIGS. 1 and 5, in operation S510, the automatic recharging system 100 may be set with the automatic recharging mode related to the advertising fee per the advertising account by the advertiser. In other words, in operation S510, the automatic recharging system 100 may be set to an on or off state of the automatic recharging mode related to the advertising fee per the advertising account. For example, the automatic recharging system 100 may be set to the on state of the automatic recharging mode by the advertiser through the advertiser terminal 120.

In operation S520, the automatic recharging system 100 may be input with the payment information for automatic recharging of the advertising fee in accordance with the automatic recharging mode, by the advertiser. In operation S520, additionally, the automatic recharging system 100 may determine whether the automatic recharging mode selected. For example, when it is determined that the automatic recharging mode is set to the on state by the advertiser, the automatic recharging system 100 may be input with the payment information such as the recharging period, the recharged amount per time, the maximum monthly limit of the recharged amount, the starting time or ending time of the automatic recharging. The recharging period which refers to a period for performing the automatic recharging may be the second period shorter than the first period. For example, in operation S520, the automatic recharging system 100 may be input with personal information, account information, credit card information, the account PIN, the credit card PIN, the authentication number, and the like of the advertiser, as the payment information related to the automatic recharging.

In operation S530, the automatic recharging system 100 may identify the payment information being input. Specifically, the automatic recharging system 100 may identify the payment information for the automatic recharging of the advertising fee, in operation S530.

In operation S540, the automatic recharging system 100 may check validity of the identified payment information. Specifically, the automatic recharging system 100 may determine whether the payment information related to the automatic recharging of the advertising fee is valid, in operation S540.

In operation S550, the automatic recharging system 100 may store the identified payment information related to the automatic recharging. For example, in operation S550, the automatic recharging system 100 may store the personal information, the account information, the credit card information, the account PIN, the authentication PIN of the advertiser, as the payment information.

In operation S560, the automatic recharging system 100 may issue the bill key related to the payment information according to a result of determining validity of the identified payment information. For example, when the payment information is determined to be valid, the automatic recharging system 100 may issue the bill key related to the payment information for the automatic recharging of the advertising fee, in operation S560.

In operation S570, the automatic recharging system 100 may store the bill key.

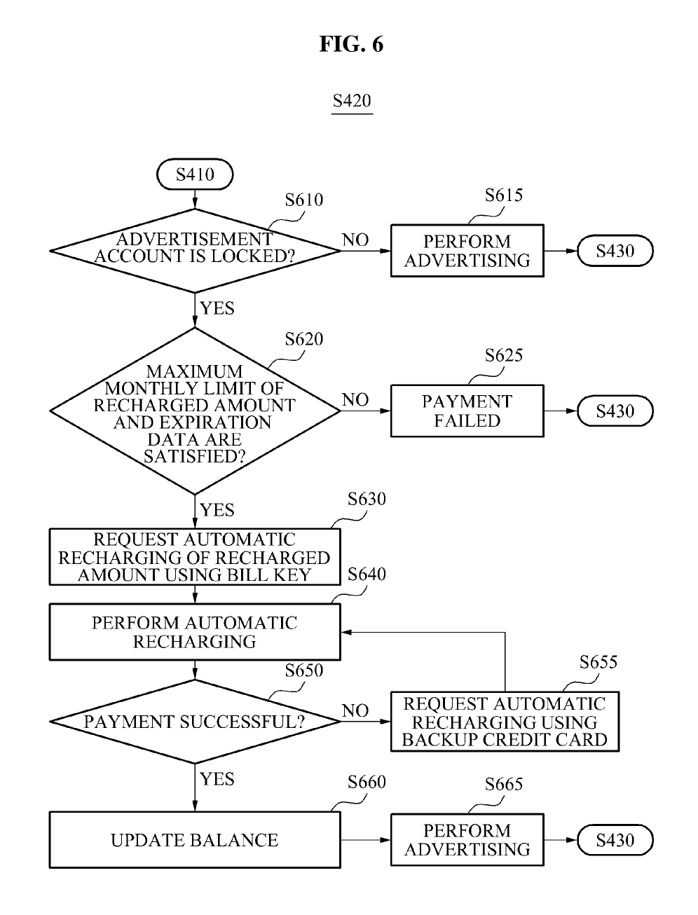

In operation S420, the automatic recharging system 100 may automatically recharge the advertising fee based on the payment information. Hereinafter, the operation of automatically recharging the advertising fee will be described in further detail with reference to FIG. 6.

FIG. 6 is a flowchart specifically illustrating a process of automatically recharging the advertising fee in the automatic recharging method according to the embodiment of the present invention.

Referring to FIGS. 1 and 6, the automatic recharging system 100 may determine whether the advertising account is locked in the first period, in operation S610. That is, in operation S610, the automatic recharging system 100 may determine whether suspension of the advertisement exposure service with respect to the advertising account is performed in the first period based on the balance of the advertising fee. For example, in operation S610, the automatic recharging system 100 may determine whether the advertising account is locked in the first period based on the balance of the advertising fee in the advertising account as the advertising is performed.

When the advertising account is not locked, the automatic recharging system 100 may perform the advertising corresponding to the advertising account in operation S615. For example, when the balance of the advertising fee is sufficient to maintain the advertising or the automatic recharging is not yet expired, the advertising account is not locked. Therefore, the automatic recharging system 100 may perform the advertising corresponding to the advertising account in operation S615.

When the advertising account is locked, in operation S620, the automatic recharging system 100 may determine whether the maximum monthly limit of the recharged amount and the expiration date of the automatic recharging are satisfied.

When it is determined that the maximum monthly limit and the expiration date are not satisfied, in operation S625, the automatic recharging system 100 may determine that the automatic recharging fails.

When it is determined that the maximum monthly limit and the expiration date are satisfied, in operation S630, the automatic recharging system 100 may request to automatically recharge the recharged amount per time using the bill key according to the payment information related to the automatic recharging. For example, when the maximum monthly limit is not exceeded and the expiration date is not passed, the automatic recharging system 100 may request to automatic recharge the advertising amount per time by the bill key according to the payment information related to the automatic recharging, in operation S630.

In operation S640, the automatic recharging system 100 may perform the automatic recharging in the second period. That is, in operation S640, the automatic recharging system 100 may perform payment of the advertising fee according to the request for the automatic recharging by the bill key.

In operation S640, the automatic recharging system 100 may determine whether—payment for the automatic recharging succeeds or fails.

When the payment is determined to be a failure, the automatic recharging system 100 may request to perform the automatic recharging using the backup credit card in operation S655, and perform the automatic recharging of the advertising fee by the backup credit card in operation S650.

When the payment for the automatic recharging is determined to succeed, the automatic recharging system 100 may update the balance of the advertising fee in operation S660. More specifically, when the payment succeeds, the automatic recharging system 100 may update the balance of the advertising fee, using the recharged amount according to the result of the automatic recharging of the advertising fee. For example, when the payment succeeds, in operation S660, the automatic recharging system 100 may update the balance included in the payment information and, in addition, display the change history of the payment information being updated.

Since the updated balance of the advertising fee is sufficient to perform the advertising, in operation S665, the automatic recharging system 100 may perform the advertising corresponding to the advertiser.

In operation S430, the automatic recharging system 100 may notify the advertiser of the result of the automatic recharging of the advertising fee. More specifically, in operation S430, the automatic recharging system 100 may automatically recharge the advertising fee corresponding to the advertiser, and notify the result of the automatic recharging to the advertiser through the advertiser terminal 120.

For example, in operation S430, the automatic recharging system 100 may notify the advertiser of the result of the automatic recharging, by transmitting the payment success message, the payment failure message, or the result notifying message to the advertiser terminal according to the result of the automatic recharging. Those messages may be transmitted in various methods such as a short message service (SMS), a multimedia message service (MMS), and an e-mail.

For example, in operation S430, when payment for the automatic recharging succeeds or payment using the backup credit card succeeds, the automatic recharging system 100 may transmit the payment success message to the advertiser terminal, thereby notifying the advertiser of the success of the automatic recharging.

When payment for the automatic recharging fails or payment using the backup credit card fails, the automatic recharging system 100 may transmit the payment failure message to the advertiser terminal, thereby notifying the advertiser of the failure of the automatic recharging.

In addition, in operation S430, when the recharged amount related to the automatic recharging exceeds the maximum monthly limit or when the expiration date for the automatic recharge is passed, the automatic recharging system 100 may transmit the result notifying message to the advertiser terminal, thereby notifying the advertiser of the payment information related to the automatic recharging.

As described above, since an advertising fee is automatically recharged according to payment information related to the advertising fee and the recharging result is notified, an advertiser may conveniently and automatically recharge the advertising fee within a predetermined period and predetermined limit amount, without separately managing the advertising fee.

In addition, an advertisement exposure service is suspended in a first period based on a balance of the advertising fee or an estimated balance, and the advertising fee is automatically recharged in a second period shorter than the first period. Accordingly, undesired suspension of the advertisement exposure service caused by lack of the advertising fee may be prevented.

The methods for automatically recharging an advertising fee according to above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method for automatically recharging an advertising fee, the method comprising:
managing payment information related to the advertising fee, the payment information providing information for suspending an advertisement exposure service based on a balance of the advertising fee for a first time period and for automatic recharging of the advertising fee for a second time period which is shorter than the first time period;
automatically recharging the advertising fee by the second time period according to the payment information; and
notifying a result of the automatic recharging.

2. The method of claim 1, wherein managing payment information comprises:
setting an automatic recharging mode per account for payment of the advertising fee;
determining how the automatic recharging mode is set;
receiving an input of the payment information according to the automatic recharging mode;
identifying the input payment information; and
storing the identified payment information.

3. The method of claim 2, further comprising:
determining validity of the payment information; and
issuing a bill key corresponding to the payment information according to a result of the validity determination.

4. The method of claim 3, wherein storing the identified payment information comprises storing the identified payment information and the issued bill key.

5. The method of claim 2, wherein receiving the input comprises receiving the payment information comprising a recharged amount per time, a maximum monthly limit of the recharged amount, and a starting time or ending time.

6. The method of claim 4, further comprising:
requesting automatic recharging using the bill key according to the payment information,
wherein the automatic recharging of the advertising fee comprises executing payment by the bill key, corresponding to the automatic recharging.

7. The method of claim 6, further comprising:
determining whether the automatic recharging succeeds; and
updating the payment information according to whether the automatic recharging succeeds.

8. The method of claim 7, further comprising:
requesting to perform the recharging again using a backup credit card when the automatic recharging fails,
wherein the automatic recharging of the advertising fee automatically recharges the advertising fee using the backup credit card.

9. The method of claim 7, wherein notifying the automatic recharging result comprises transmitting a payment success message, a payment failure message, or a result notifying message according to the result of the automatic recharging.

10. The method of claim 9, wherein notifying the automatic recharging result comprises transmitting the payment success message when payment corresponding to the automatic recharging succeeds or when payment using the backup credit card succeeds.

11. The method of claim 9, wherein notifying the automatic recharging result comprises transmitting the payment failure message to when payment corresponding to the automatic recharging fails or when payment using the backup credit card fails.

12. The method of claim 9, wherein notifying the result of the automatic recharging comprises transmitting the result notification message to the advertiser when a paid amount corresponding to the automatic recharging exceeds a maximum monthly limit amount or when an expiration date for the automatic recharging is passed.

13. The method of claim 7, wherein updating the payment information comprises updating the balance contained in the payment information when the automatic recharging succeeds, and
wherein the method further comprises displaying a change history related to the updated payment information.

14. A non-transitory computer readable recording medium storing a program comprising instructions that, when executed by a computer, implement the method of claim 1.

15. A system to automatically recharging an advertising fee, the system comprising:
a payment information management unit to manage payment information related to the advertising fee, the payment information providing information for suspending an advertisement exposure service based on a balance of the advertising fee for a first time period and for automatic recharging of the advertising fee for a second time period which is shorter than the first time period;
an automatic recharging unit to automatically recharge the advertising fee by the second time period according to the payment information; and
a notification unit to notify a result of the automatic recharging.

16. The system of claim 15, wherein the payment information management unit comprises:
an input unit to to receive information on an automatic recharging mode per account for payment of the advertising fee or the payment information related to the automatic recharging;
a determination unit to determine selection of the automatic recharging mode;
an identification unit to identify the received payment information; and
a storage unit to store the identified payment information.

17. The system of claim 16, wherein
the determination unit determines validity of the payment information, and
wherein the system further comprises an issue unit to issue a bill key corresponding to the payment information according to a result of the validity determination.

18. The system of claim 17, wherein the storage unit stores the identified payment information and the issued bill key.

19. The system of claim 16, wherein the input unit receives the payment information comprising a recharged amount per time, a maximum monthly limit of the recharged amount, or a ending time of the automatic recharging.

20. The system of claim 18, wherein the automatic recharging unit performs payment corresponding to the automatic recharging using the bill key according to a request for recharging using the bill key.

21. The system of claim 20, wherein
the determination unit determines whether the automatic recharging succeeds, and
the storage unit stores the payment information updated according to the result of the automatic recharging.

22. The system of claim 21, wherein, in response to failure of the payment, the automatic recharging unit performs a payment corresponding to the automatic recharging using a backup credit card.

23. The system of claim 20, wherein the notification unit transmits a payment success message, a payment failure message, or a result notification message according to the result of the automatic recharging.

24. The system of claim 23, wherein the notification unit transmits the payment success message when payment corresponding to the automatic recharging succeeds or when payment using the backup credit card succeeds.

25. The system of claim 23, wherein the notification unit transmits the payment failure message when the payment corresponding to the automatic recharging fails or when the payment using the backup credit card fails.

26. The system of claim 23, wherein the notification unit transmits the result notification message when a paid amount corresponding to the automatic recharging exceeds a maximum monthly limit amount or when an expiration date for the automatic recharging is passed.

27. The system of claim 21, wherein the storage unit stores the payment information updated with regard to the balance when the automatic recharging succeeds, and
wherein the system further comprises a display unit to display a change history related to the updated payment information.
